(19) United States
(12) Patent Application Publication
(10) Pub. No.: US 2009/0020073 A1
(43) Pub. Date: Jan. 22, 2009

(54) Deer conditioning system

(76) Inventor: Daniel D. Hansen, Pensacola, FL (US)

Correspondence Address: Peter Loffler, P.O. Box 1001, Niceville, FL, 32588-1001, US

(21) Appl. No.: 11/827,971

(22) Filed: Jul. 16, 2007

(51) Int. Cl. A01K 5/02; H02N 6/00

(52) U.S. Cl. 119/51.11; 136/243; 222/52; 43/1

(57) ABSTRACT

A deer conditioning system uses a feeder that has a lid that automatically opens at a specified time, namely the start of hunting hours, and closes at a specified time, the end of hunting hours. When the lid is open, the system dispenses a deer pleasing stimuli so as to attract deer, the deer being rewarded by the contents of the feeder for responding to the stimuli. Alternately, in a typical always open feeder, either a deer attracting stimuli dispenser is provided and is programmed to release stimuli during hunting hours or a deer repulsing stimuli dispenser is provided and programmed to release stimuli during non-hunting hours upon motion being detected proximate the feeder via a motion detector, or both types of dispensers are provided and appropriately programmed.

### BACKGROUND OF THE INVENTION

1. Field of the Invention

The present invention relates to a system that conditions deer, via operant and classical conditioning, by the use of programmed release stimuli dispensers associated with a feeder, in order to prevent the deer from becoming nocturnal during hunting season.

2. Background of the Prior Art

Every year thousands of outdoorsmen begin the hunting season with high expectations and visions of successful and bountiful hunts. Large sums of money are spent on hunting equipment including the latest gadgets. The various deer scents, deer calls, deer lures, game feeders, and other paraphernalia that are sold each season help increase the early odds for some hunters. However, as the season progresses, many hunters feel that there is a diminishing of deer sightings and are baffled by this phenomena. Various reasons are cited for this lack of sightings including such as it being too hot, too windy, too dry, low pressure fronts moving in, bad acorn crop, moon is wrong, among others. While animal sighting do diminish, the animals are, in fact, still there on the hunting grounds. Anyone who has placed a trail camera on the grounds can attest to the fact that the animals have not left, only the sightings have fallen off. A close examination of the evidence from the trail camera reveals that the deer are active, but mainly at night, well past legal hunting hours in most jurisdictions. The deer have learned to survive by going nocturnal.

To combat this problem, hunters turn to the new and improved deer call, or the latest and greatest deer scent from some high tech deer laboratory. However, the gadget industry, by placing “weapons” into the hunter's arsenal, actually help perpetuate the nocturnal activity in the game animals.

The problem is not with the gadgets themselves, as many tend to be effective in the early part of the season for attracting the animals, the problem is altogether psychological. The latest gadgets are destined to fail as the hunting season progresses and the deer are conditioned by the various gadgets, as well as in the long run, as the conditioned deer survive from one hunting season to the next.

The problem of nocturnally conditioned game animals has four main causal components, namely seasonal hunting pressures, the use of deer calls, the use of deer scents and lures, and the use of deer feeders.

In a natural setting that is void of seasonal hunting pressures, the natural stimuli for deer activity include hunger, curiosity, mating, etc. Animal responses are to travel to a food source, seek the source of a desired sound or scent, travel in search of mating opportunities, etc. Outside of the hunting season, there is little or no negative reinforcement (consequence) to such responses with a very high positive reinforcement (reward). Therefore, outside of hunting season, the natural daytime activities of the deer are largely unaffected. However, during hunting season, there is much negative reinforcement and very little positive reinforcement to the various daytime activities. As hunting occurs almost exclusively during daylight hours, deer are conditioned to become nocturnal in order to avoid the hunters and survive.

The use of a deer call negatively reinforces the deer's response every time the call is used. A deer sound issues from an artificial call, which causes the deer to respond by going toward the call in search of another deer. The result is that the deer never finds another deer in response to the artificial call. Instead, the deer is met by a hunter trying to harm the deer. In short order, the deer learn not to respond to the artificial deer call. As hunters do not sound their calls at night, the deer's best bet for survival is to become nocturnal.

Similarly, the use of a deer scent or lure also negatively reinforces the deer's response every time the scent or lure is used. A deer scent is released, which causes the deer to respond by going toward the scent in search of another deer. The result is that the deer never finds another deer in response to the released scent. Instead, the deer is again met by a hunter trying to harm the deer. In short order, the deer learn not to respond to the released scents. As hunters do not dispense their scents at night, the deer's best bet for survival is to become nocturnal.

The use of conventional deer feeders has a somewhat different dynamic. The use of a feeder positively rewards the deer in response to the stimuli by providing food, albeit at the wrong time. As a deer will encounter hunting pressure by responding to the deer feeder during the day, and as deer feeders are always available, both day and night, the deer learns to respond to the feeder at night when no hunting pressure is present.

What is needed is a system that helps prevent the deer from becoming conditioned to be nocturnal during the hunting season so that deer sightings do not diminish as the season progresses. Such a system must be simple in design and construction and simple in its operation.

### SUMMARY OF THE INVENTION

The deer conditioning system of the present invention addresses the aforementioned needs in the art by providing a system that positively reinforces a deer's response to attractive stimuli such as the release of a scent or the making of a call. As the deer conditioning system works during daylight hours—hunting hours—the deer, by being positively reinforced each time the stimuli is released, will positively respond to the stimuli and not become nocturnal. Additionally, the system can be inverted so that a negative response is issued should the deer attempt to respond to a positive stimuli during nighttime hours. The deer conditioning system is relatively simple in design and construction and is easy to deploy and operate.

The deer conditioning system of the present invention is comprised of a feeder that has a lid that is capable of opening and closing via the operation of a motor. A dispenser is located proximate the feeder (either attached directly to the feeder or lid or to a point nearby such as a post or a tree), the dispenser being capable of releasing a deer attracting stimuli of any design. A programmable controller is operationally connected to the motor and to the dispenser such that the controller is programmed to activate the motor at a first specified time so as to open the lid and to activate the motor at a second specified time so as to close the lid and such that the controller causes the dispenser to release the stimuli whenever the lid is open. A battery is electrically connected to the motor and the controller and may have a solar collector attached to the feeder and be electrically connected to the battery for recharging the battery. The dispenser may be a whistle and the stimuli a call, may be a scent atomizer and the stimuli a scent, may be a visual stimuli dispenser, etc.

Alternately, the deer conditioning system comprises a conventional feeder or feed station of any appropriate design known in the art, that does not restrict access to the feed. A first dispenser is located proximate the feeder (either attached directly to the feeder or lid or to a point nearby such as a post or a tree) and capable of releasing a first stimuli. A programmable controller is operationally connected to the first dispenser such that the controller is programmed to activate the first dispenser at a first specified time and to deactivate the dispenser at a second specified time. A battery is electrically connected to the controller and may have a solar panel electrically connected to the battery for recharging the battery. This embodiment may include a motion detector operationally connected to the first dispenser such that the first stimuli is a deer repulsing stimuli and the first dispenser dispenses the first stimuli whenever the motion detector detects a motion. In such a case, the first specified time is at the end of hunting hours and the second specified time is the start of hunting hours (or other times as appropriate).

Alternately, the first stimuli may be a deer attracting stimuli and the first specified time is at the start of hunting hours and the second specified time is the end of hunting hours. In this embodiment, a second dispenser may also located proximate the feeder and capable of releasing a second stimuli with the second dispenser operationally connected to the controller. A motion detector is operationally connected to the second dispenser. The controller is further programmed to activate the second dispenser at the second specified time and to deactivate the second dispenser at the first specified time and such that the second dispenser releases the second stimuli whenever the motion detector detects a motion. In such a case, the first stimuli is a deer attracting stimuli and the second stimuli is a deer repulsing stimuli and the first specified time is the start of hunting hours and the second specified time is the end of hunting hours (or other times as appropriate).

A camera may be located proximate the feeder while a remote controller transmitter is operationally connected to the controller for remote control operation of the device in any configuration.

Basically, the dispenser releases a deer repulsing or a deer attracting stimuli or both at specific programmable times and is located proximate a game feeding station in order to become associated with the feeding station via classical and operant conditioning.

### BRIEF DESCRIPTION OF THE DRAWINGS

FIG. 1 is a perspective view, partially cut away, of the deer conditioning system operational and ready for positively reinforcing deer behavior.

FIG. 2 is a perspective view of the deer conditioning system non-operational.

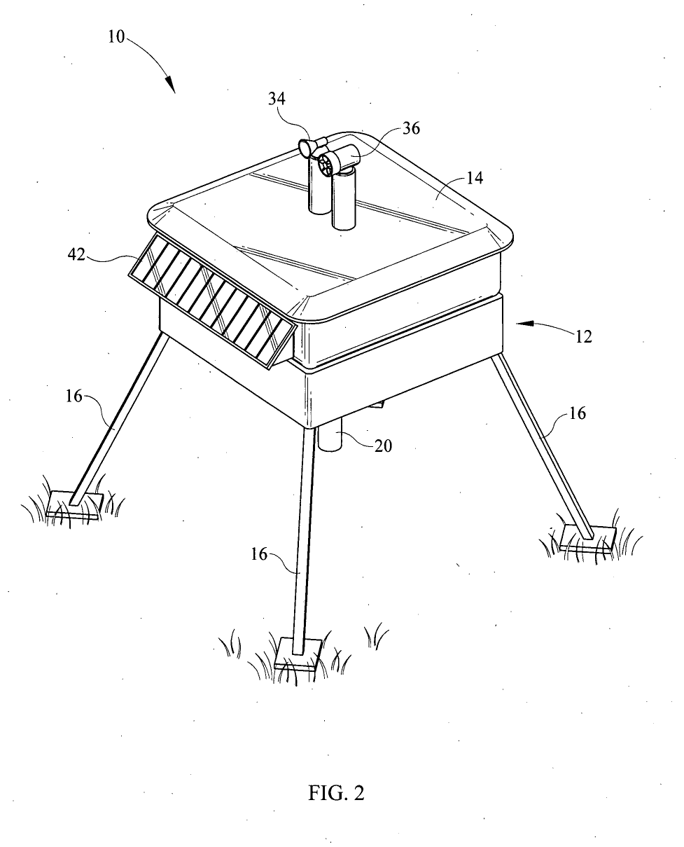

FIG. 3 is a sectioned view of the deer conditioning system.

FIG. 4 is an elevation view of an alternate embodiment of the deer conditioning system attached to a conventional deer feeder.

FIG. 5 is an elevation view of the deer conditioning system of FIG. 4 attached in a different manner.

Similar reference numerals refer to similar parts throughout the several views of the drawings.

### DESCRIPTION OF THE PREFERRED EMBODIMENT

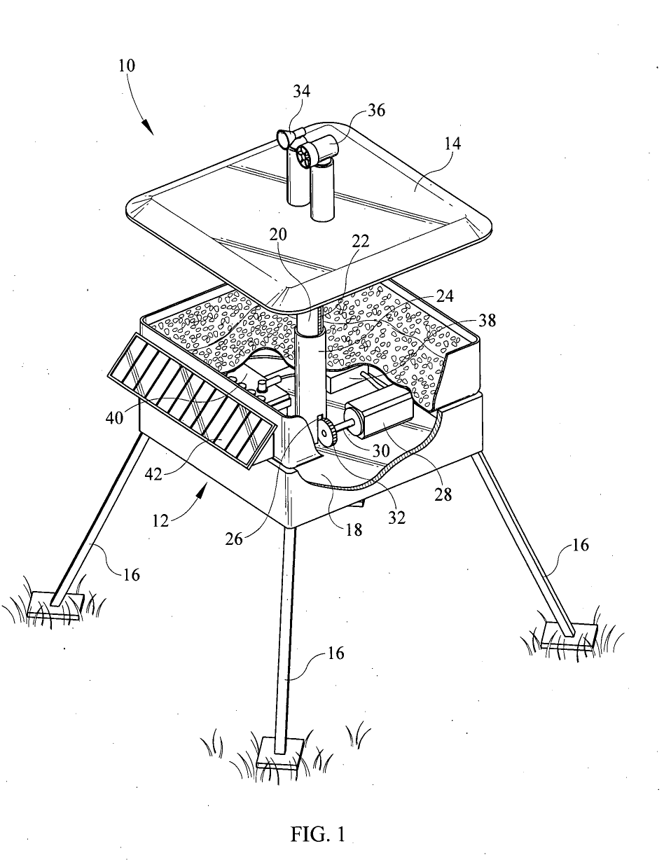

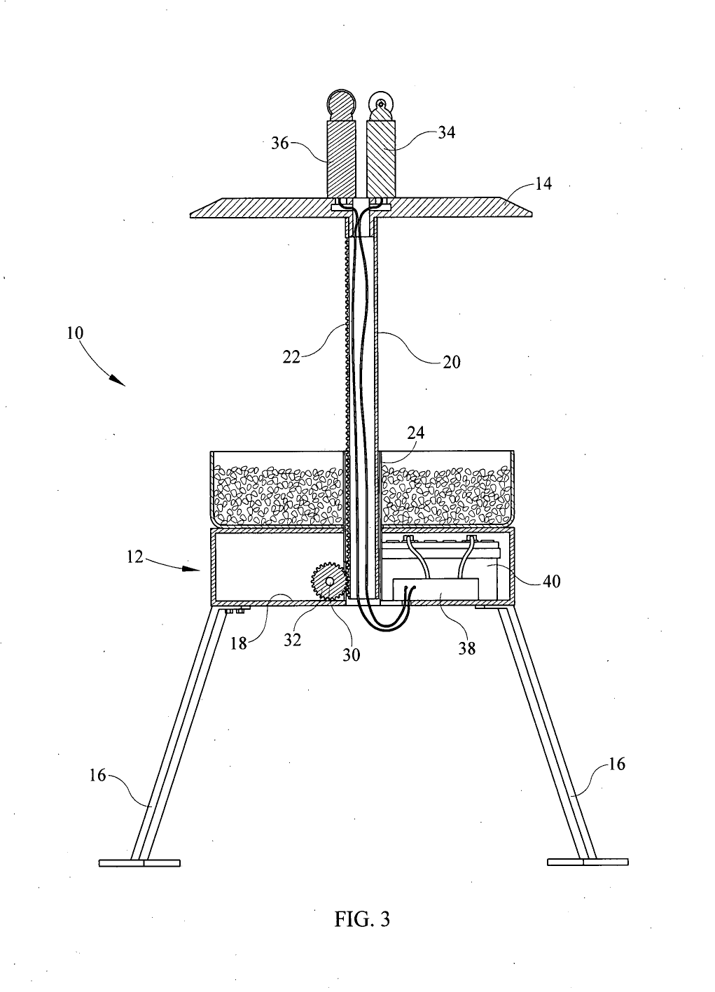

Referring now to the drawings, it is seen that the deer conditioning system of the present invention, generally denoted by reference numeral 10, is comprised of a typical deer feeder 12 of any appropriate design that has a lid 14 that is capable of opening and closing. The feeder 12 may be of any appropriate design commonly found in the art such as the illustrated square feeder 12 that has a series of pedestal legs 16 extending downwardly from the floor 18 of the feeder 12. Other designs of the feeder may also be employed. As seen, extending downwardly from the lower surface of the lid 14 is a hollow stanchion 20 that has a rack gear 22 extending along a portion of its length. The stanchion 20 passes through a hollow tube 24 that extends upwardly from the floor 18 of the feeder 12, the tube 24 having an opening 26 proximate the feeder's floor 18. A motor 28 is located within the feeder 12 and has a shaft 30 extending outwardly therefrom, such that when the motor 28 is operational, the shaft 30 rotates. Located on the end of the shaft 30 is a gear 32, the gear 32 protruding into the opening 26 of the tube 24, the gear 32 gearably meshing with the rack gear 22 of the stanchion 20. Activation of the motor 28 causes the shaft 30, and thus the gear 32, to rotate, such that the rotating gear 32 causes the stanchion 20 to move either up or down within the tube 24, depending on the direction of rotation of the gear 32. When the lid 14 is in an open position, as seen in FIGS. 1 and 3, and the motor 28 is activated, the gear 32 turns in a direction (clockwise in FIG. 3) so that the stanchion 20 lowers within the tube 24 with the motor 28 running until the lid 14 is fully closed. Similarly, when the lid 14 is closed, and the motor 28 is activated, the gear 32 turns in a direction so as to raise the stanchion 20 and thereby open the lid 14. A timer within a controller 38, more fully discussed below, may be used to control the cycle of operation of the motor 28 so that the lid 14 is raised and lowered the appropriate amount, or limit switches (not illustrated) may be used for proper motor 28 cycle control. It is expressly understood that other configurations of an automatically opening and closing feeder can be used in keeping within the scope and spirit of the present invention. For example, the lid may be hingedly attached to a side of the feeder such that a solenoid causes the lid to open and close, etc.

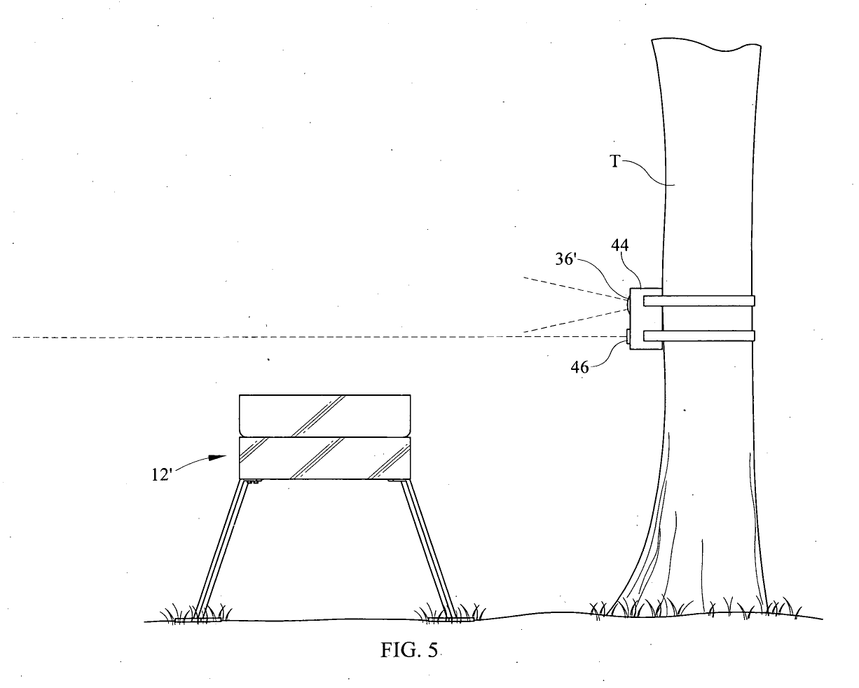

Located on top of the lid (or elsewhere on the feeder 12 or even remote of the feeder 12, such as attached to a post or a tree T that is in close proximity to the feeder, an example of a remote location for a dispenser is illustrated in FIG. 5 for an alternate embodiment of the deer conditioning system 10′ of the present invention) are one or more attracting stimuli dispensers 34 which can include the illustrated whistle which is an aerosol based whistle (the replaceable aerosol cartridge (not illustrated) held within the body of the whistle) that uses electricity to release the aerosol as is well known in the art. The call released by the whistle is a non-alarming call that is pleasing to deer, which sound may include mystical sub-sonic vibrations. The attracting stimuli dispenser 34 can also include a scent dispenser which is an atomizer that releases scent held within a replaceable cartridge (not illustrated) via an electric current, such devices also being well known in the art. The scent dispensed by the scent dispenser is a deer pleasing scent, such a corn, apple, etc. Other attracting stimuli 34 can also be provided including visual stimuli, tactile stimuli, etc., all designed to be attractive to the deer.

A controller 38 is communicatively connected to each of the attracting stimuli dispensers 34, either directly by wire as illustrated or via wireless communication as is well known in the art. The controller 38 is also communicatively connected to the motor 28. The controller 38 is programmable in order to control operation of the motor 28, and the various attracting stimuli dispensers 34.

A battery 40 is located within the feeder and provides electricity for operation of the motor 28, the attracting stimuli dispensers 34, and the controller 38. A solar collector 42 provides trickle down charging of the battery 40. If the attracting stimuli dispensers 34 are located remote of the feeder and are in wireless communication with the controller, 38, then each such attracting stimuli dispenser 34 has its own battery and may include their own solar collectors.

In order to use the deer conditioning system 10 of the present invention, the feeder 12 is stocked with the desired feed. The controller 38 is programmed so that the lid 14 opens only at a specific hour, for example just after day break when hunting is permitted, and closes a specific hour, for example just before sunset when hunting is not permitted. When the lid 14 is closed, none of the attracting stimuli dispensers 34 are activated. When the lid 14 is open, which corresponds to the time that hunting is permitted, and a hunter desires a deer to approach the feeder 12, the attracting stimuli dispensers 34 are activated. For example, the whistle is activated so as to emit a deer attracting sound and the scent dispenser is also activated in order to emit a deer pleasing scent. The frequency of sound emission by the various attracting stimuli dispensers 34, may also be programmed via the controller 38 or may be preset—each individual dispenser 34 may have its own frequency of activation. As the deer responds to a pleasing stimuli dispensed by the attracting stimuli dispensers 34, the deer, upon approaching the feeder 12 is rewarded every time by having feed available. This reward is irrespective of whether or not a hunter is present. In this way, the deer is positively rewarded each time during the hours that a hunter wants the deer to approach the feeder, namely the hunting hours. As the lid 14 is closed, the deer receive no reinforcement during nocturnal hours via the dispensing of attracting stimuli.

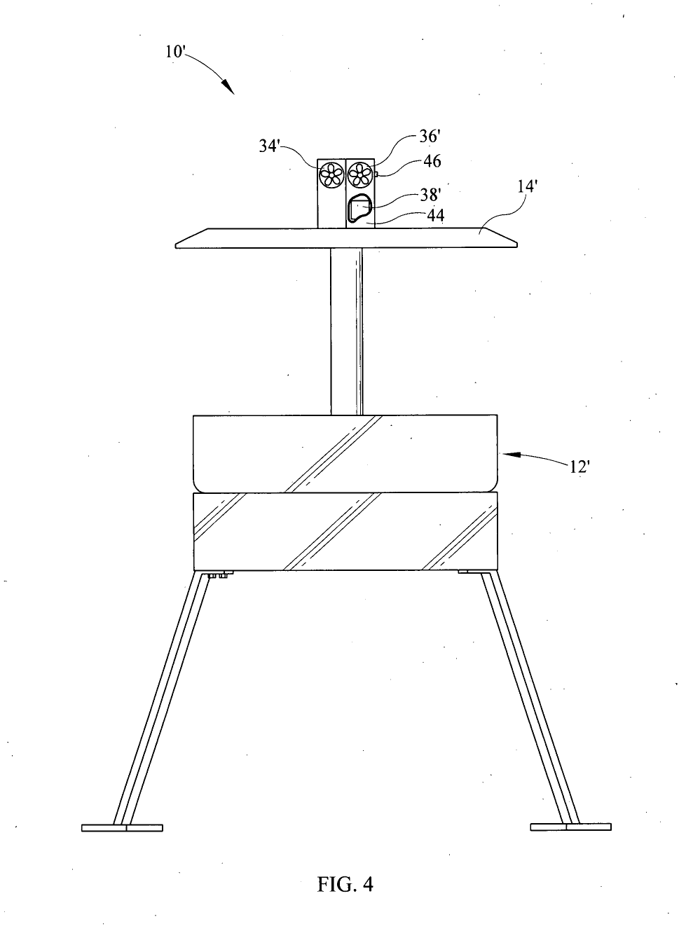

As seen in FIGS. 4 and 5, an alternate embodiment of the deer conditioning system 10′ of the present invention relies on a standalone unit that comprises a conventional deer feeder 12′ of any appropriate design known in the art that has unlimited access to the feed, that is, its lid 14′ (if it even has a lid 14′) is manually opened and closed and is considered to be always open. In this embodiment 10′, either an attracting stimuli dispenser 34′, as described above for the limited access feeder 12, or a repulsing stimuli dispenser 36′, that dispenses a negative stimuli to the deer such as predator urine scent, a loud sharp sound, a bright flash, etc., or both are attached to lid 14′ or other portion of the feeder 12′ or can be attached external of the feeder 12′ such as attached to a tree T or a post in similar fashion to the limited access feeder 12. As seen in FIG. 5, when the dispensers 34′ or 36′ are attached remote of the feeder 12′ such dispensers 34′ or 36′ are held within a self-contained unit in a housing 44 that is battery operated. In either location, the negative dispenser 36′ has an appropriate motion detector 46. The deer conditioning system 10′ also has a controller 38′ for controlling the device 10′ and is battery (not illustrated) operated, a solar collector may also be electrically attached to this battery. The controller 38′ is communicatively connected to the dispensers 34′ and 36′. In this embodiment of the deer conditioning system 10′, if only the attracting stimuli dispenser 34′ is used, the device 10′ is programmed such that the attracting stimuli dispenser 34′ is active only during hunting hours so that when the dispenser 34′ is active and dispenses an attracting sound, scent, etc., and the deer responds to this attracting stimuli, then the deer is rewarded with feed available at the feeder 12′. If only the repulsing stimuli dispenser 36′ is used, the device 10′ is programmed such that the repulsing stimuli dispenser 36′ is active only during non-hunting hours so that when the dispenser 36′ is active and the deer approach the feeder 12′, the motion detector 46 detects the deer and activates the repulsing stimuli dispenser 36′ thereby giving the deer positive punishment for approaching the feeder 12′ at the wrong time. Similarly, if both the attracting stimuli dispenser 34′ and the repulsing stimuli dispenser 36′ are used, the device 10′ is programmed such that the attracting stimuli dispenser 34′ is active only during hunting hours so that when the dispenser 34′ is active and dispenses an attracting sound, scent, etc., and the deer responds to this attracting stimuli, then the deer is rewarded with feed available at the feeder 12′ and the repulsing stimuli dispenser 36′ is active only during non-hunting hours so that when the repulsing stimuli dispenser 36′ is active and the deer approach the feeder 12′, the motion detector 46 detects the deer and activates the repulsing stimuli dispenser 36′ thereby giving the deer positive punishment for approaching the feeder 12′ at the wrong time.

In either embodiment 10 or 10; of the deer conditioning system, one or more remote cameras may be installed on or near the respective feeder 12 or 12′ and the various dispensers controlled via a remote control system, to allow the hunter, who is not hunting at a given time, to control operation of the device 10 or 10′ in order to help condition the deer appropriately.

While the invention has been particularly shown and described with reference to embodiments thereof, it will be appreciated by those skilled in the art that various changes in form and detail may be made without departing from the spirit and scope of the invention.

I claim:

1. A conditioning system comprising:
a game feeder having a lid that is capable of opening and closing via the operation of a motor;
a dispenser located proximate the feeder and capable of releasing a deer attracting stimuli;
a programmable controller operationally connected to the motor and to the dispenser such that the controller is programmed to activate the motor at a first specified time so as to open the lid and to activate the motor at a second specified time so as to close the lid and such that the controller causes the dispenser to release the stimuli whenever the lid is open; and
a battery electrically connected to the motor.

2. The conditioning system as in claim 1 further comprising a solar collector attached to the game feeder and electrically connected to the battery for recharging the battery.

3. The conditioning system as in claim 1 wherein the dispenser dispenses a sound.

4. The conditioning system as in claim 1 wherein the dispenser dispenses a scent.

5. The conditioning system as in claim 1 wherein the dispenser dispenses a visual stimuli.

6. The conditioning system as in claim 1 further comprising:
a camera adapted to be located proximate the feeder; and
a transmitter operationally connected to the controller for operating the controller via remote control.

7. A conditioning system comprising:
a dispenser adapted to be located proximate a deer feeder and capable of releasing a deer repulsing stimuli;
a motion detector operationally connected to the dispenser;
a programmable controller operationally connected to the dispenser such that the controller is programmed to activate the dispenser at a first specified time and to deactivate the dispenser at a second specified time such that the controller causes the dispenser to release the stimuli whenever the motion detector detects a motion; and
a battery electrically connected to controller.

8. The conditioning system as in claim 7 further comprising a solar panel electrically connected to the battery for recharging the battery.

9.
The conditioning system as in claim 7 wherein the dispenser dispenses a sound.

10.
The conditioning system as in claim 7 wherein the dispenser dispenses a visual stimuli.

11. The conditioning system as in claim 7 wherein the dispenser dispenses a scent.

12. The conditioning system as in claim 7 further comprising:
a camera adapted to be located proximate the feeder; and
a transmitter operationally connected to the controller for operating the controller via remote control.

13. A conditioning system comprising:
a first dispenser adapted to be located proximate a deer feeder and capable of releasing a first stimuli;
a programmable controller operationally connected to the first dispenser such that the controller is programmed to activate the first dispenser at a first specified time and to deactivate the dispenser at a second specified time; and
a battery electrically connected to the controller.

14. The conditioning system as in claim 13 further comprising a solar panel electrically connected to the battery for recharging the battery.

15. The conditioning system as in claim 13 further comprising a motion detector operationally connected to the first dispenser and such that the first stimuli is a deer repulsing stimuli and the first dispenser dispenses the first stimuli whenever the motion detector detects a motion.

16. The conditioning system as in claim 15 wherein the first specified time is at the end of hunting hours and the second specified time is the start of hunting hours.

17. The conditioning system as in claim 13 wherein the first stimuli is a deer attracting stimuli, the first specified time is at the start of hunting hours and the second specified time is the end of hunting hours.

18. The conditioning system as in claim 13 further comprising:
a second dispenser adapted to be located proximate the feeder and capable of releasing a second stimuli, the second dispenser operationally connected to the controller;
a motion detector operationally connected to the second dispenser; and
such that the controller is further programmed to activate the second dispenser at the specified time and to deactivate the second dispenser at the first specified time and such that the second dispenser releases the second stimuli whenever the motion detector detects a motion.

19. The conditioning system as in claim 18 wherein the first stimuli is a deer attracting stimuli and the second stimuli is a deer repulsing stimuli.

20. The conditioning system as in claim 19 wherein the first specified time is the start of hunting hours and the second specified time is the end of hunting hours.

21. The conditioning system as in claim 18 wherein the first specified time is the start of hunting hours and the second specified time is the end of hunting hours.

22. The conditioning system as in claim 18 further comprising:
a camera adapted to be located proximate the feeder; and
a transmitter operationally connected to the controller for operating the controller via remote control.

23. The conditioning system as in claim 13 further comprising:
a camera adapted to be located proximate the feeder; and
a transmitter operationally connected to the controller for operating the controller via remote control.

24. A dispenser that releases a deer repulsing or a deer attracting stimuli at specific programmable times adapted to be located proximate a game feeding station in order to become associated with the feeding station via classical and operant conditioning.

25. The conditioning system as in claim 24 wherein the dispenser dispenses a sound.

26. The conditioning system as in claim 24 wherein the dispenser dispenses a visual stimuli.

27. The conditioning system as in claim 24 wherein the dispenser dispenses a scent.

28. The conditioning system as in claim 24 further comprising:
a camera adapted to be located proximate the feeder; and
a transmitter operationally connected to the dispenser for operating the dispenser via remote control.
